(19) United States
(12) Patent Application Publication
(10) Pub. No.: US 2026/0071100 A1
(43) Pub. Date: Mar. 12, 2026

(54) Film Material Capable of Solving Printing Materials Incapable of Washing with Water

(71) Applicant: CHANCE LINE INDUSTRIAL CO., LTD., Siansi Township (TW)

(72) Inventor: Ming-Hsien YAO, Siansi Township (TW)

(21) Appl. No.: 19/011,849

(22) Filed: Jan. 7, 2025

Related U.S. Application Data
(63) Continuation-in-part of application No. 18/883,359, filed on Sep. 12, 2024.
(63) Continuation-in-part of application No. 18/931,621, filed on Oct. 30, 2024.

(51) Int. Cl. C09J 7/40; C09J 167/00

(52) U.S. Cl. CPC C09J 7/40; C09J 167/00; C09J 2301/304; C09J 2301/41; C09J 2400/16; C09J 2475/00

(57) ABSTRACT

A film material capable of solving printing materials incapable of washing with water comprises: a release layer, a film layer and an adhering layer. The film layer is provided on a surface of the release layer; the adhering layer is provided on a surface of the film layer; the film layer and the adhering layer are capable of separating from the release layer. The film material can be attached to a printing material. The film material is capable of protecting a printing layer of the printing material and isolating the printing layer externally, so that a graphic cut out from the film material and the printing material is capable of withstanding water washing.

### CROSS-REFERENCE TO RELATED APPLICATIONS

This application claims the benefit of priorities from the prior U.S. patent application Ser. No. 18/883,359, filed on Sep. 12, 2024 and Ser. No. 18/931,621, filed on Oct. 30, 2024, the entire contents of which are incorporated herein by reference.

### FIELD OF THE INVENTION

The invention relates to a film material, particularly referring to a film material applied to printing materials. The film material makes printed graphics of printing materials capable of withstanding water washing.

### DESCRIPTION OF THE RELATED ART

There are printing materials sold in the DIY market, which are heat printing materials or heat transfer printing materials that is printable. People can print on the printing materials and cut out graphics from the printing materials, and then fix the graphics of the printing materials on the fabric, such as clothes, through heat pressing, making the clothes to have unique graphics.

There is no protection for the graphics on the clothes that are printed on the printing materials through heat printing. Therefore, when the clothes are washed with water, the printed graphics heat printed on the clothes (heat printing graphics) will be damaged or faded, resulting in incomplete graphics. Customers'complaints about the printing materials sold in the DIY market are all about water-washing problems. This is because the graphics of the printable materials sold in the DIY market are all printed by Epson, Canon or HP home printers or laser printers, or the ink of the home printers is replaced with sublimation ink to print graphics. The original purpose of this kind of home printers is to print on paper, the graphics printed by the home printers cannot withstand water, and therefore the washing condition of the graphics certainly cannot be good.

In addition, the printed graphics on the fabric will fade after being exposed to sunlight, and the colors of the graphics will not be vivid, affecting the appearance.

Another problem with conventional printing materials is that when a home printer is used to print sublimation ink on the printing material, and then the graphics are heat printed on the fabric, the colors of the sublimation ink will be affected by the fabric, resulting in the graphics'colors being dull, not vivid, and unclear.

### SUMMARY OF THE INVENTION

The invention is capable of overcoming the drawbacks of the prior art. One object of the invention is to provide a film material capable of solving a problem of graphics of printing materials incapable of washing with water or withstanding water washing, so that heat printed graphics on a fabric are capable of withstanding water washing, remaining intact after washing.

One object of the invention is to provide a film material capable of solving printing materials incapable of washing with water, so that heat printed graphics from the printing materials are capable of withstanding sunlight without fading, and the graphics can maintain vivid colors.

One object of the invention is to provide a film material capable of solving printing materials incapable of washing with water, so that graphics printed and heat printed with sublimation ink are capable of maintaining vivid and bright colors and clarity.

The invention provides a film material capable of solving printing materials incapable of washing with water, comprising:
a release layer;
a film layer provided on a surface of the release layer; and an adhering layer provided on a surface of the film layer; the film layer and the adhering layer are capable of separating from the release layer.

The film material is attached to a printing material, and the printing material has a printing layer capable of printing a pattern. A graphic can be cut out from the film material and the printing material, and the graphic can be combined on an object. The film material is capable of protecting the printing layer of the printing material and isolating the printing layer from outside, the printing layer of the printing material will not be damaged by water, so that the graphic cut out from the film material and the printing material is capable of withstanding water washing.

Preferably, the film layer is transparent or translucent. Preferably, the adhering layer is transparent or translucent and is capable of revealing the pattern on the printing layer.

Preferably, one surface of the release layer has various textures; a surface of the film layer combined with the surface of the release layer is a textured surface with textures.

Preferably, a surface of the film layer combined with the release layer is a textured surface with textures, the texture of the film layer becomes the texture of the graphic.

Preferably, the film material comprises a positioning film, a surface of the positioning film has a glue layer; the film layer and the adhering layer are capable of separating from the release layer, and adhering to the surface of the positioning film with the glue layer, the film layer and the adhering layer are capable of separating from the positioning film and adhering back and positioning on the glue layer of the positioning film after separation. When the film layer is separated from the positioning film, a glue of the glue layer will not stick to the film layer. Thereby, a graphic can be cut out from the film layer and the adhering layer, after the cut graphic is separated from the positioning film, the graphic can still be adhered back and positioned on the positioning film.

Preferably, the film layer is a light-reflective film layer with a layer of transparent or translucent micro glass beads, enabling the graphic to reflect light.

Preferably, further comprising: a layer of zinc sulfide disposed on the micro glass bead layer, making light reflected by the graphic to be multicolor light.

Preferably, the film layer or the adhering layer has at least one additive, and the additive is not a component of the film layer or the adhering layer. Preferably, the film layer or the adhering layer is added with at least one of the following additives: luminous material, fluorescent material, pearlescent material, optical-variation material, temperature-variable material, glitter powder, ultraviolet absorber or antioxidant. The ultraviolet absorber makes the film layer resistant to sunlight, prevents the graphic from fading, and keeps colors of the graphic vivid. The luminous material, such as luminous powder and luminous particles, gives the film layer a luminous effect. The pearlescent material, such as pearlescent powder, gives the film layer an iridescent (multicolor) effect. The glitter powder, such as colored fine aluminum foil, gives the film layer a metallic luster. The antioxidant prevents oxidation or deterioration of the film layer.

Preferably, both the film layer and the adhering layer of the film material have at least one additive, or only the film layer of the film material has at least one additive, or only the adhering layer of the film material has at least one additive.

Preferably, a metal layer, such as an aluminum layer, is provided on one surface of the film layer, the metal layer does not cover the film layer completely to enhance metallic feel and uniqueness of surface textures of the film layer.

Preferably, the textures of the film layer are concave-convex textures or textures forming a laser effect, so that the surface of the film layer has different kinds of texture effects.

Preferably, one surface of the film layer has micro optical components, including micro convex lenses, micro concave lenses, and micro convex or concave water droplet-shaped components, to enable a surface of the film layer to produce various light reflection and refraction effects.

Preferably, the adhering layer is an adhesive made of polypropylene (PP), thermoplastic elastomer (TPE), thermoplastic polyurethane (TPU), polyethersulfone (PES), ethylene vinyl acetate (EVA) or polyurethane reactive (PUR).

Preferably, the adhering layer is a thermoplastic elastomer (TPEE) adhesive or a polyester adhesive. When the pattern of the graphic is formed by printing with sublimation ink, the TPEE or polyester adhesive enables the sublimation ink to develop color, providing the graphic with vivid colors.

Preferably, the film layer has at least two stacked layer portions, at least comprising a first layer portion and a second layer portion, the second layer portion is sandwiched between the first layer portion and the adhering layer.

Preferably, a surface of the first layer portion of the film layer is a textured surface with textures, so that the film material has textures.

Preferably, at least one of the layer portions of the film layer is added with at least one of the following additives: ultraviolet absorber, antioxidant, luminous material, pearlescent material, fluorescent material, optical-variation material, temperature-variable material or glitter powder.

Preferably, the first layer portion is added with ultraviolet absorber or antioxidant, while the second layer portion is added with luminous material, fluorescent material, pearlescent material, optical-variation material, temperature-variable material or glitter powder.

Preferably, the first layer portion is a light-reflective film and has a layer of micro glass beads; the second layer portion has no additives or at least one additive added, for example, luminous material. The film material forms a light-reflective and luminous film.

### BRIEF DESCRIPTION OF DRAWINGS

FIG. 1 is a cross-sectional view of a film material capable of solving thermoprinting materials incapable of washing with water according to a first preferred embodiment of the invention.

FIGS. 2 to 5 show cross-sectional views of the film material according to second to fifth preferred embodiments of the invention, in which FIG. 3A is a top view of FIG. 3, FIG. 3B is the actual film material of FIG. 3, FIG. 3A omits an adhering layer.

FIGS. 6 and 7 are cross-sectional views of the film material according to sixth and seventh preferred embodiments of the invention.

FIG. 8 is a cross-sectional view of the film material according to an eighth preferred embodiment of the invention.

FIG. 9 is a cross-sectional view of the film material according to a ninth preferred embodiment of the invention.

FIG. 10 is a cross-sectional view of the film material according to a tenth preferred embodiment of the invention.

FIG. 11 is a cross-sectional view of the film material according to an eleventh preferred embodiment of the invention.

FIG. 12 shows a method of using the film material of FIG. 11.

FIG. 13 is a cross-sectional view of a printing material.

FIGS. 14 to 21 show a forming process of heat printing a graphic on a fabric.

FIGS. 22 to 33 show different application examples of heat printing a graphic on a fabric.

FIGS. 34 to 37 show four composite film materials, each of the composite film materials comprises the film material of the invention.

### DETAILED DESCRIPTION OF THE INVENTION

The invention provides a film material capable of solving heat printing materials incapable of washing with water. More specifically, it is a film material that makes printed graphics of a printing material (heat printing material) capable of withstanding water washing and without fading after being exposed to sunlight. The film material is used to combine with a printing material. Before combining, people, home users or businesses can use a home printer or a professional printer to print patterns on the printing material. Then, a graphic is cut out from the combined film material and printing material, and then the graphic is heat printed/heat pressed on an object, such as a fabric.

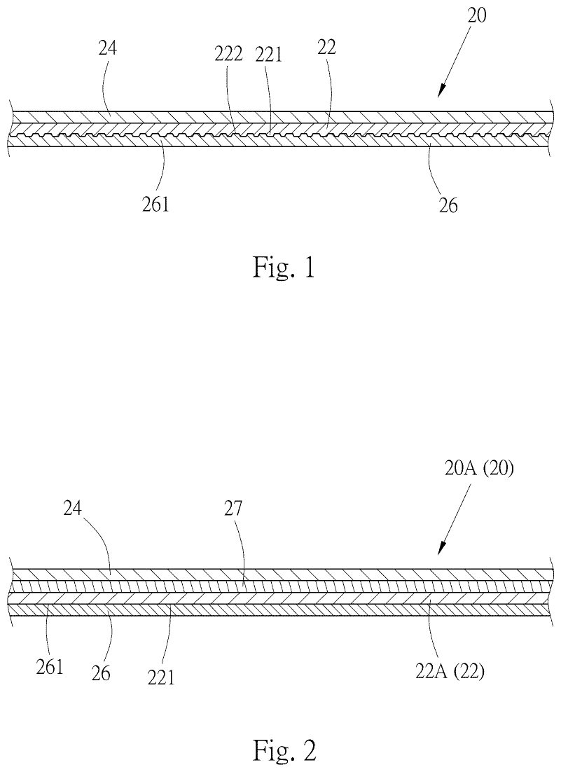

FIG. 1 is a film material 20 according to a first preferred embodiment of the invention, which comprises: a film layer 22, an adhering layer 24 and a release layer 26, one surface of the film layer 22 is combined with one surface of the release layer 26; the adhering layer 24 is provided on another surface of the film layer 22. The film layer 22 and the adhering layer 24 are capable of separating from the release layer 26.

The release layer 26 can be a release film or a release paper, having a first surface and a second surface located on opposite sides, and the first surface can be made with textures, so that the surface is an embossed surface 261 with textures, the textures can be various textures, such as concave and convex textures, preferably micro concave and convex textures. The concave and convex textures can be regular or irregular textures, including, but not limited to, dotted or striped textures.

When the release layer 26 is a release film, its material can be PET (polyethylene terephthalate), CPP (cast polypropylene) or OPP (oriented polypropylene). The textures can be directly formed on the surface 261 of the release layer 26, for example, directly embossed on the surface 261 of the release layer 26. Or, a surface of the release layer 26 can be combined with a resin containing a photocurable material, so that the surface of the release layer 26 has a resin layer, and the textures are made on the resin layer to form the embossed surface 261. Release properties of the release layer 26 can be formed by physical properties of a material of the release layer 26 itself, or the release layer 26 can be coated with a release substance.

The film layer 22 is a transparent or translucent layer, such as a polymer thin film, for example, a polymer film of polyurethane (PU) resin, which can be polycarbon polyurethane, polyether polyurethane or polyester polyurethane, but is not limited thereto. The film layer 22 can be formed by coating liquid PU on the release layer 26.

A surface of the film layer 22 facing the release layer 26 is a textured surface 221, and preferably has textures 222. Liquid resin is coated on the embossed surface 261 of the release layer 26 to shape the film layer 22, and the film layer 22 forms the textured surface 221 and the concave and convex embossed textures 222. The textures 222 are mirror images of textures of the embossed surface 261. The textures 222 of the textured surface 221 can also be formed by embossing after the film layer 22 and the adhering layer 24 are combined with each other. After the textures 222 are formed, the textured surface 221 of the film layer 22 is combined with the release layer 26.

The textures 222 on the textured surface 221 of the film layer 22 are capable of producing different surface effects. For example, the textures 222 on the textured surface 221 of the film layer 22 have a transparent laser effect in appearance, that is, the textured surface 221 presents a surface effect similar to that after laser treatment, or a 2D/3D visual effect. The textures 222 can be formed through the embossed surface 261 of the release layer 26.

FIG. 2 is a second preferred embodiment of the film material 20 (20A). One surface of the film layer 22 (22A) of the film material 20A is plated with a layer of zinc sulfide 27, so that light refracted by the film layer 22A have an iridescent (multicolor) effect, that is, light refracted by the film layer 22A are multicolor light. The zinc sulfide layer 27 is located between the film layer 22A and the adhering layer 24.

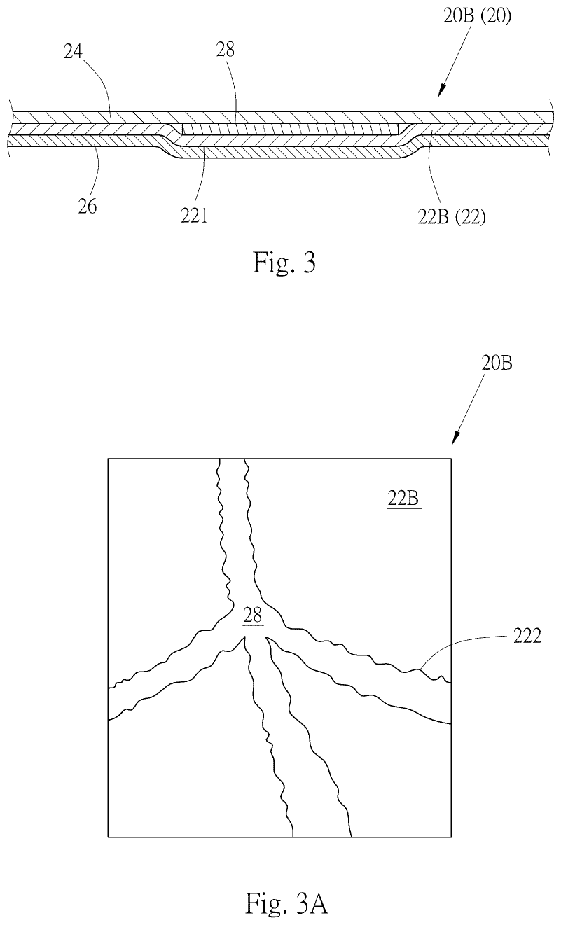

FIG. 3, FIG. 3A and FIG. 3B are a third preferred embodiment of the film material 20 (20B). A surface of the film layer 22 (22B) of the film material 20B is provided with a metal layer 28. The metal layer 28 can be a layer of chromium plating, aluminum plating, or other suitable metal layers, which is disposed on a surface of the film layer 22B by plating or coating, and is located between the film layer 22B and the adhering layer 24, so that the film layer 22B forms a bronzing film. Please refer to FIG. 3A and FIG. 3B, which are top views of the film material 20B, FIG. 3A shows only the film layer 22B and the metal layer 28. The metal layer 28 is only disposed on a partial surface of the film layer 22B and does not cover the entire film layer 22B. Therefore, parts of the film layer 22B that are not covered by the metal layer 28 still remain transparent or translucent. The metal layer 28 can be in a regular shape/texture or an irregular shape/texture, including dotted and striped shapes. FIGS. 3A and 3B illustrate a shape/texture of the metal layer 28, but is not limited thereto. The irregular-shaped metal layer 28 makes a surface of the film layer 22B have the special textures 222.

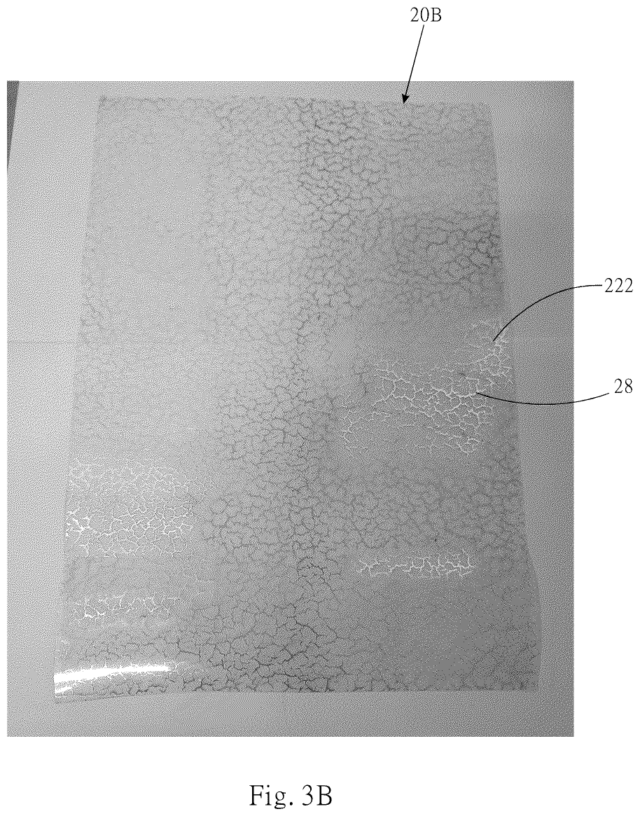

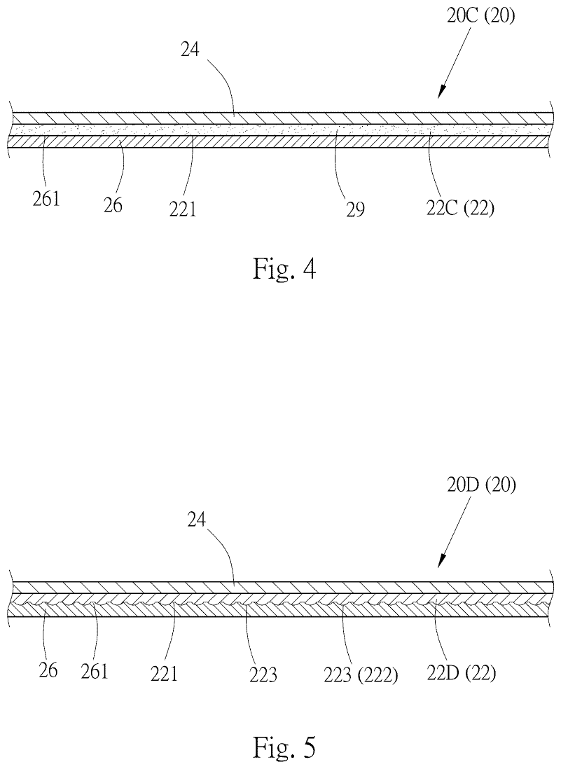

FIG. 4 is a fourth preferred embodiment of the film material 20 (20C). The film layer 22 (22C) of the film material 20C is mixed with an additive 29. The additive 29 can be pearlescent powder, glitter powder (micro aluminum foil with color), luminous powder (luminous particles) or fluorescent powder. The pearlescent powder gives the film layer 22C an iridescent (multicolor) effect, and the glitter powder gives the film layer 22C a metallic luster, different colors of glitter powder produce different colors of metallic luster. The luminous powder makes the film layer 22C have a luminous effect and capable of emitting light at night.

Alternatively, the additive 29 of the film layer 22C is a temperature-variable powder, making the film layer 22C a transparent or translucent temperature-variable film (thermochromic film), so that its surface can change color through changes in temperature.

Alternatively, the additive 29 of the film layer 22C is an optical-variable powder, which makes the film layer 22C a transparent or translucent optical-variable film (photochromic film), so that its surface can change color through irradiation of light of a specific frequency, such as UV rays.

Alternatively, the additive 29 of the film layer 22C is a spice/perfume, so that the film layer 22C has a fragrance, and even a fragrance with a mosquito repellent effect can be used.

Alternatively, the additive 29 of the film layer 22C is an anti-ultraviolet auxiliary, such as an ultraviolet absorber (UV absorber), so that the film layer 22C can resist ultraviolet rays, absorb ultraviolet rays, and resist sunlight.

Alternatively, the additive 29 of the film layer 22C is an antioxidant, which has an antioxidant effect and prevents oxidation and deterioration of chemical substances or high polymers thereof.

The film layer 22C can be added with a variety of the above-mentioned additive 29 at the same time, for example, added with optical-variable powder, ultraviolet absorber, and antioxidant at the same time, so that the optical-variable film can resist sunlight and oxidation; or added with temperature-variable powder, ultraviolet absorber, antioxidant, luminous powder, fluorescent powder, glitter powder at the same time, making the film layer 22C have a metallic luster and a temperature-variable effect, capable of resisting sunlight and oxidation, and emitting luminous light at night. Proportions of the additive 29 depend on required conditions.

FIG. 5 is a fifth preferred embodiment of the film material 20 (20D). The textured surface 221 of the film layer 22 (22D) of the film material 20D forms a fine optical structure and is provided with micro optical components, such as provided with micro convex lenses 223 or concave lenses, or micro water droplet-shaped components (small water droplets for short), preferably the convex lenses 223, concave lenses, or small water droplets are formed by the embossed surface 261 of the release layer 26. Each of the convex lenses 223 is a convex structure, protruding from a surface of the film layer 22D; each of the concave lenses is a concave structure, recessed from the textured surface 221 of the film layer 22D; each of the small water droplets can be a convex structure or a concave structure. Through the convex lenses 223, concave lenses or small water droplets, a surface of the film layer 22D produces light reflection and refraction effects. The convex lenses 223, the concave lenses or the small water droplets form the textures 222 on a surface of the film material 20D.

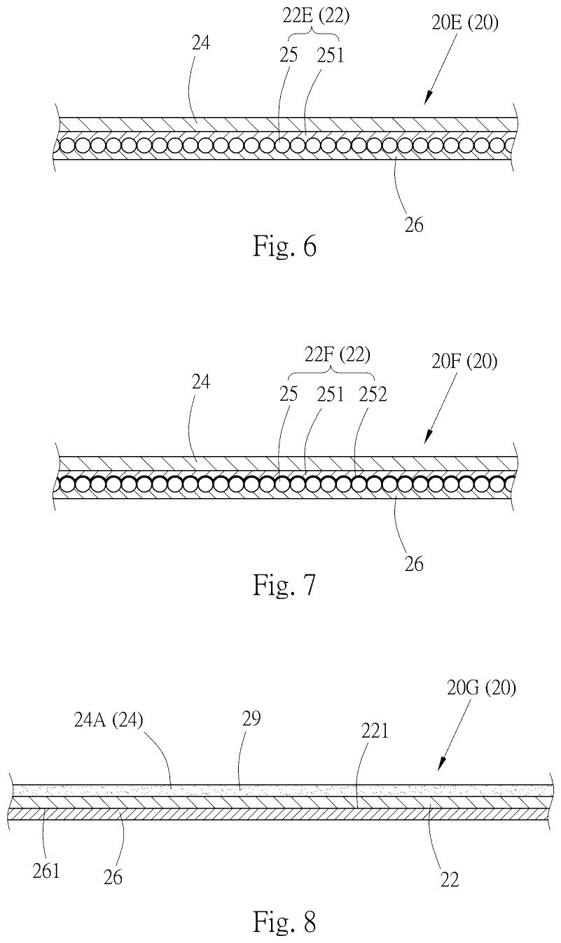

FIG. 6 shows the film material 20 (20E) according to a sixth preferred embodiment of the invention. The film layer 22 (22E) is a transparent or translucent light-reflective film layer. The film material 20E uses a transparent or translucent light-reflective layer 25 as the film layer 22 (22E). The light-reflective layer 25 is a layer of micro glass beads. The micro glass bead layer 25 is disposed and bonded onto a layer of transparent glue/resin 251, the glue/resin 251 serves as an adhesive, and the micro glass bead layer 25 is combined with the adhering layer 24 through the glue layer/resin layer 251. The release layer 26 is disposed on another surface of the micro glass bead layer 25.

FIG. 7 is a seventh preferred embodiment of the film material 20 (20F). The film material 20F has a transparent or translucent film layer 22 (22F), an adhering layer 24 and a release layer 26. The film layer 22F comprises a micro glass bead layer 25, a layer of transparent or translucent glue or adhesive 251 and a layer of zinc sulfide 252. The zinc sulfide layer 252 is coated or plated on a surface (inner surface) of the micro glass bead layer 25, located between the micro glass bead layer 25 and the adhering layer 24. The adhesive 251 is TPU, PUR (polyurethane reactive) or acrylic series hot melt glue. The micro glass bead layer 25 of the film layer 22F can reflect light, and through the zinc sulfide layer 252, the reflected light have an iridescent effect. The film layer 22F and the adhering layer 24 are capable of separating from the release layer 26 together.

In the embodiments disclosed in this specification, the film layers 22, 22F with the zinc sulfide layers 27, 252 and the film layer 22C added with pearlescent powder or glitter powder are translucent film materials. The film layer 22 in FIG. 1, the film layer 22B with a metal layer in FIG. 3, and the film layers 22D, 22E in FIGS. 5 and 6 can be transparent or translucent film materials.

The adhering layer 24 is a transparent or translucent adhering layer. Preferably, the adhering layer 24 is a transparent thermal adhering layer, such as hot melt glue, which generates viscosity when being heated. The adhering layer 24 is preferably made of resin, which can be hot melt glue made of polypropylene (PP), thermoplastic elastomer (TPE), thermoplastic polyurethane (TPU), polyethersulfone (PES) or ethylene vinyl acetate (EVA). Polyurethane reactive (PUR) hot melt glue can also be used as the adhering layer 24. When sublimation ink is used, thermoplastic polyester elastomer (TPEE) hot melt glue or polyester adhesive can be used as the adhering layer 24 to keep a color of the sublimation ink vivid. The adhering layer 24 can also be a polyester adhering layer or an adhering layer that can be bonded to printing materials. The adhering layer 24 is disposed on another surface of the film layer 22 by coating or attaching. The film layer 22 (22A-22F) and the adhering layer 24 are capable of separating from the release layer 26 together.

FIG. 8 is the film material 20 (20G) according to an eighth preferred embodiment of the invention. The film layer 22 can be any of type of the above mentioned preferred embodiments, and its surface has the various textures 222 or no textures. Wherein the above-mentioned various additives 29 (ultraviolet absorber, antioxidant, optical-variable powder, temperature-variable powder, luminous powder, fluorescent powder, glitter powder) are added to the adhering layer 24 (24A) and are not added to the film layer 22. The adhering layer 24A with additives is transparent or translucent. Thereby, the film material 20G is a transparent or translucent film material. Through the added additives 29, the film material 20G has functions or effects described in the aforementioned embodiments.

In another embodiment, both the film layer 22 and the adhering layer 24 have additives. For example, some of the additives 29 can be added to the film layer 22 and the other additives 29 can be added to the adhering layer 24. For example, UV absorber is added to the film layer 22, and optical-variable powder or temperature-variable powder is added to the adhering layer 24 (hot melt glue layer).

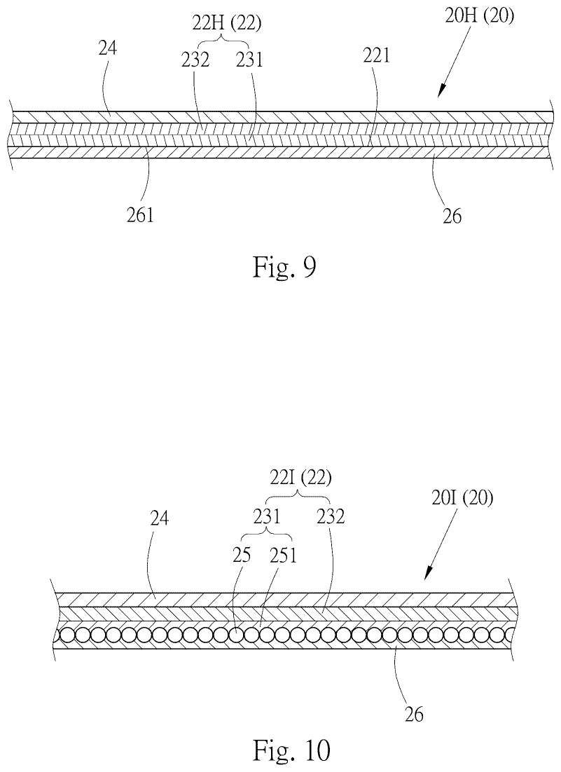

FIG. 9 shows the film material 20 (20H) according to a ninth preferred embodiment of the invention, which comprises: a film layer 22 (22H), an adhering layer 24 and a release layer 26. Wherein the film layer 22H is composed of a plurality of polymer films combined through coating or attaching, and has two overlapping layer portions or more than two overlapping layer portions, such as two layer portions 231, 232. The first layer portion 231 is coated on the release layer 26, and the second layer portion 232 is coated on the first layer portion 231. The two layer portions 231, 232 can both be transparent or translucent polymer films, or one of them can be transparent and the other can be translucent. The first layer portion 231 is in contact with the release layer 26, and the second layer portion 232 is combined with the adhering layer 24 and is sandwiched between the first layer portion 231 and the adhering layer 24. Wherein one surface of the first layer portion 231 is the textured surface 221 with the textures (222). For example, one surface of the first layer portion 231 that is in contact with the release layer 26 is the textured surface 221, and the textures (222) of the textured surface 221 can be any type of textures disclosed in this specification, so that the film material 20H has a texture effect.

In addition, at least one of the aforementioned additives 29 or more than one of the aforementioned additives 29 can be added to any one of the two layer portions 231, 232, or both of the two layer portions 231, 232 have the additives 29. A plurality of the additives 29 can be added to the two layer portions 231, 232 respectively. Through the additives 29 added to the first layer portion 231 and/or the second layer portion 232, the film material 20H has functions or effects described in the aforementioned embodiments. An embodiment of the additives 29 of the film material 20H is that the first layer portion 231 is added with antioxidant and ultraviolet absorber, and the second layer portion 232 is added with temperature-variable powder, optical-variable powder, glitter powder, luminous powder or fluorescent powder. Thereby, the second layer portion 232 is sandwiched between the first layer portion 231 with antioxidant and ultraviolet absorber and the adhering layer 24, which isolates the second layer portion 232 from oxygen and the outside, preventing the additives 29 and added materials in the second layer portion 232 as well as the second layer portion 232 from oxidation, deterioration or degradation

FIG. 10 shows the film material 20 (20I) according to a tenth preferred embodiment of the invention. The film material 20I is similar to the film material 20H in FIG. 9. The film layer 22 (22I) has two layer portions or more than two layer portions that are stacked, for example, the first layer portion 231 and the second layer portion 232. Wherein the first layer portion 231 is a light-reflective film, comprising a micro glass bead layer 25 and a layer of the transparent or translucent glue or adhesive 251; the second layer portion 232 can be added with at least one of the additives 29 described in the aforementioned embodiments, for example, the second layer portion 232 is added with luminous powder or fluorescent powder, so that the film material 20I forms a light-reflective and luminous film material.

The first layer portion 231 of the film layer 22I can also have the additives 29. The adhering layer 24 of the two film materials 20H, 20I can also have the additives 29.

FIG. 13 shows a printable printing material 10, which comprises: a printing layer 12 and a hot melt glue layer 14, both the printing layer 12 and the hot melt glue layer 14 are disposed on a carrier layer 16. Ink or toner can be used to print patterns on a surface of the printing layer 12 through an inkjet printer or a laser printer. The printing layer 12 and the hot melt glue layer 14 can be torn off from the carrier layer 16 together.

The film material 20 (including 20A to 20H) of the invention is used to combine with the printing material 10, and then a graphic 45 cut out from the printing material 10 and the film material 20 are heat printed/heat pressed on an object, such as fabric. The film material 20 is capable of protecting the graphic 45. A process of heat printing the graphic 45 to an object (clothing) is described in U.S. patent application Ser. No. 18/883,359 and Ser. No. 18/931,621, the contents of which are incorporated herein by reference. The process and its finished products are briefly described hereinafter.

Please refer to FIG. 14, users print a pattern 32 with ink or toner on the printing layer 12 of the printing material 10 using a home printer 30 of EPSON, Canon or HP through computer printing. The pattern 32 can be various patterns such as people, animals, non-people, non-animals, text or non-text, etc., and can be monochrome or multicolor. Users can design and print patterns, styles and colors of the pattern 32 by themselves. Ink that can be printed on the printing layer 12 can be dye ink or sublimation ink.

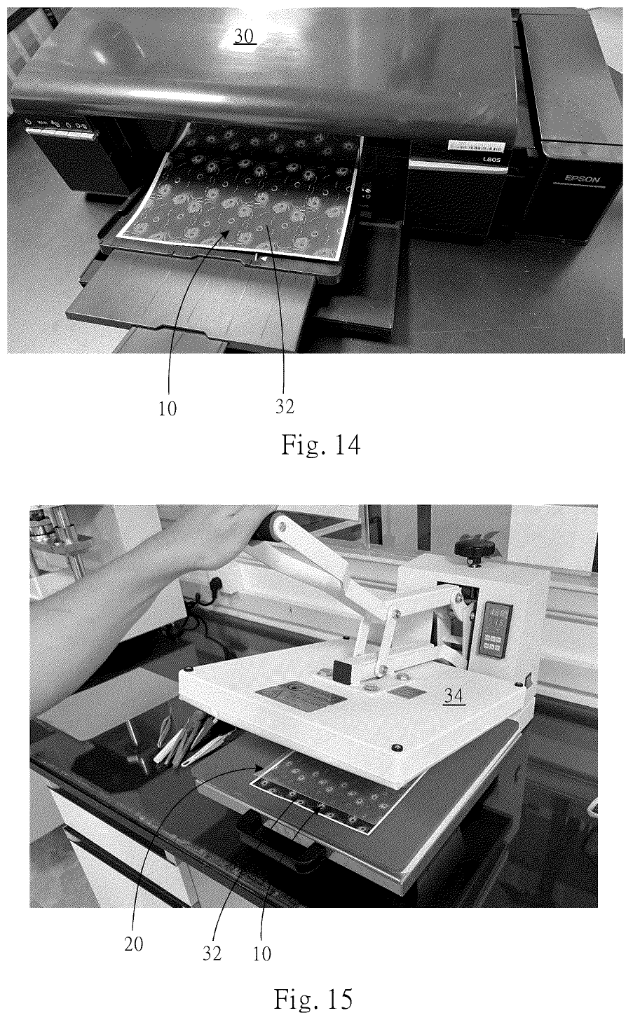

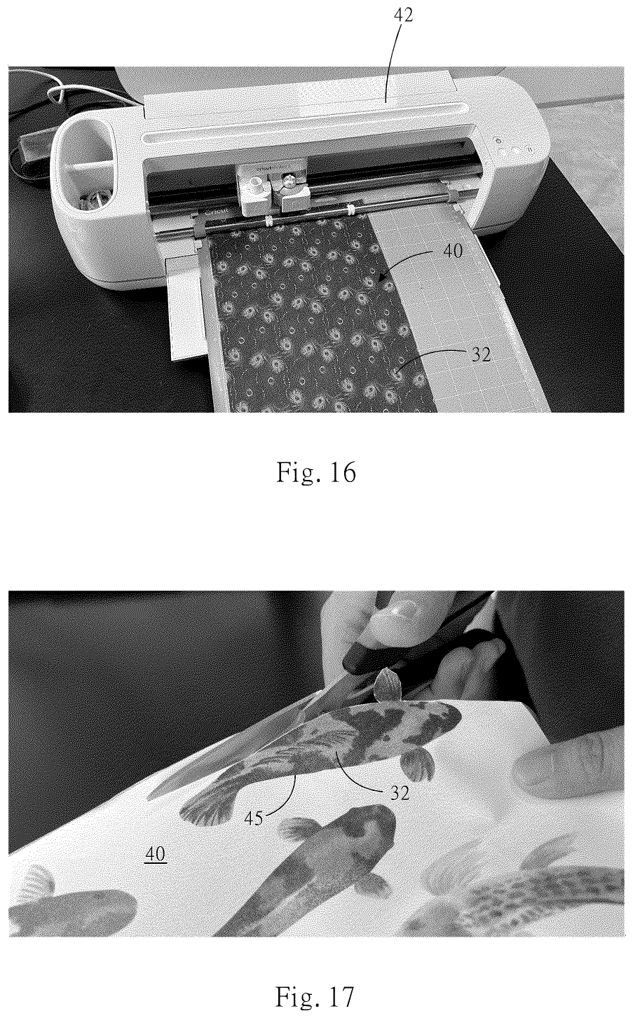

As shown in FIG. 15, the film material 20 and the printing material 10 of the invention are thermally attached with each other using an electric iron or a heat press 34, so that the adhering layer 24 of the film material 20 is heated to generate viscosity and adhere to the printing material 10 to form a stacked composite film material 40 shown in FIG. 16, and the film material 20 covers and protects the pattern 32. After the film material 20 and the printing material 10 are adhered with each other, the release layer 26 is torn off, leaving only the film layer 22 and the adhering layer 24 of the film material 20 adhering to the printing material 10. The film layer 22 is adhered on the printing layer 12 to cover the pattern 32 so that the pattern 32 will not be in contact externally.

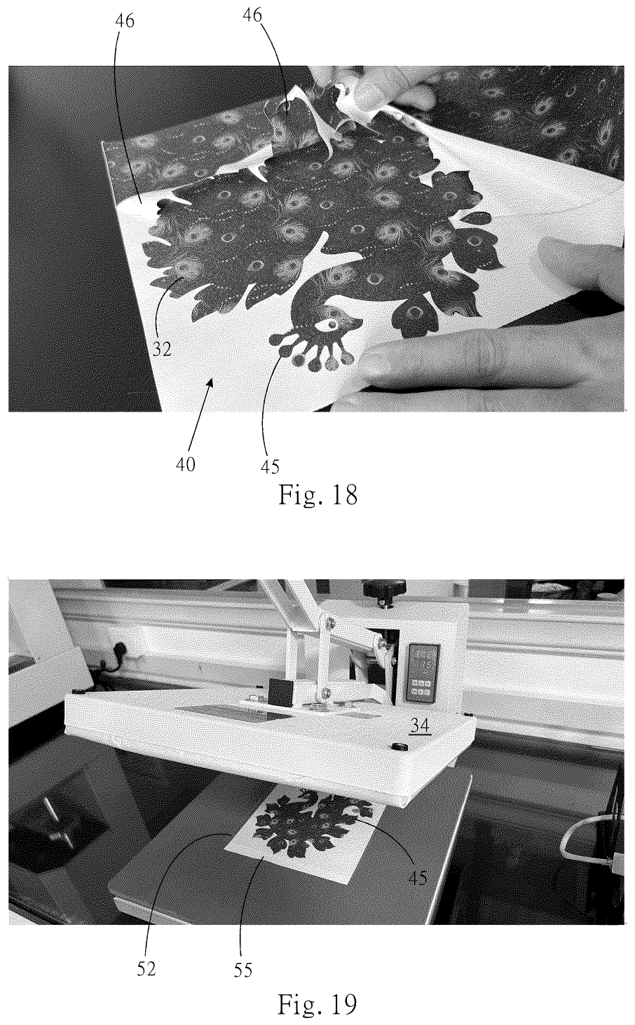

Then, users or businesses can use a home cutting machine 42 to cut out the required graphic 45 from the composite film material 40 as shown in FIG. 16, or as shown in FIG. 17, manually use a utility knife or scissors to cut out the required graphic 45 from the stacked composite film material 40. As shown in FIG. 18, a waste material 46 other than the graphic 45 is torn off, leaving only the graphic 45. The graphic 45 formed by cutting comprises the hot melt glue layer 14, the printing layer 12 with the pattern 32 printed on it, the adhering layer 24 and the film layer 22 of a same shape and stacked together from bottom to top.

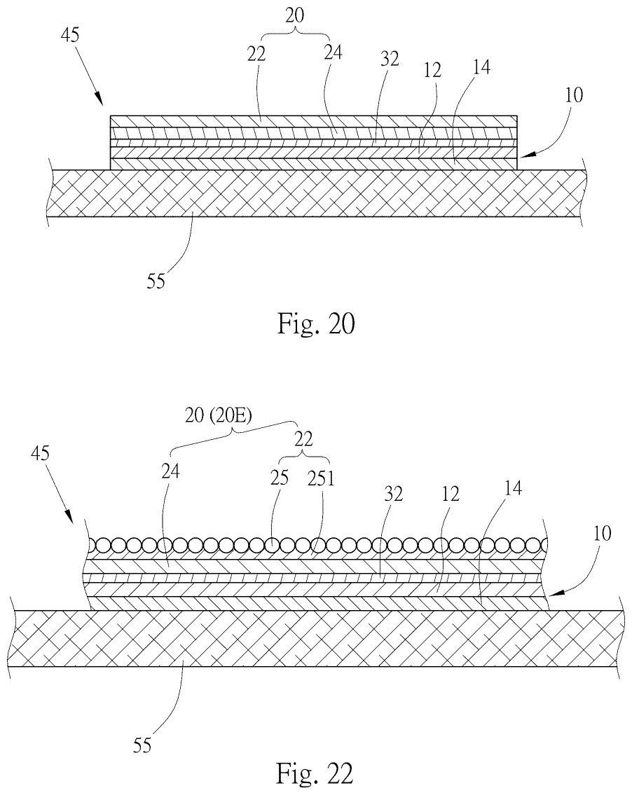

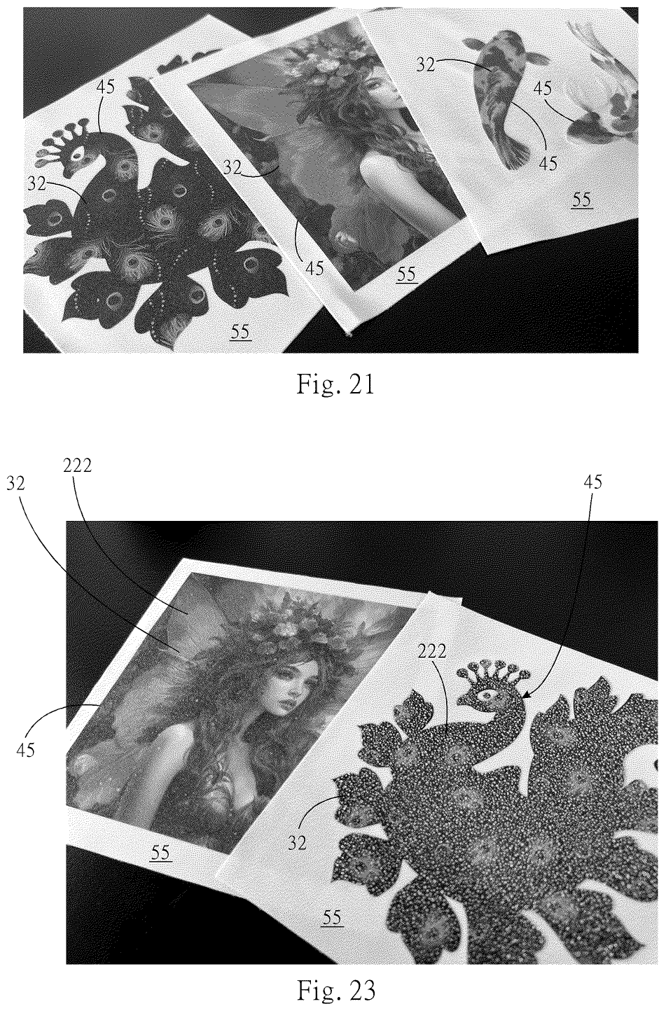

Then, as shown in FIG. 19, the hot melt glue layer 14 of the graphic 45 is contacted with a fabric 55, and the graphic 45 is heated with an electric iron or the heat press 34, so that the graphic 45 adheres to a surface of the fabric 55. As shown in FIG. 20 and FIG. 21, the graphic 45 and the pattern 32 thereof are covered by the film layer 22 and isolated externally.

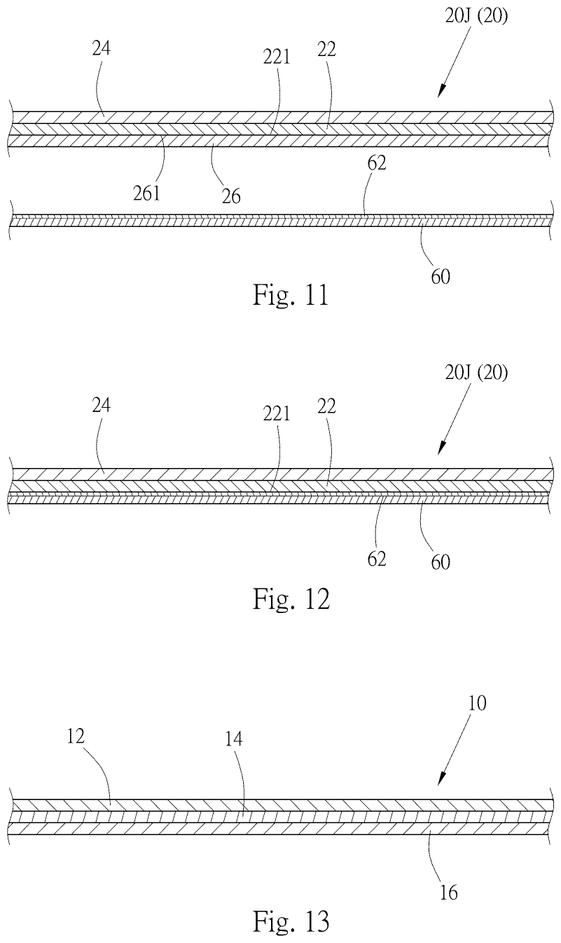

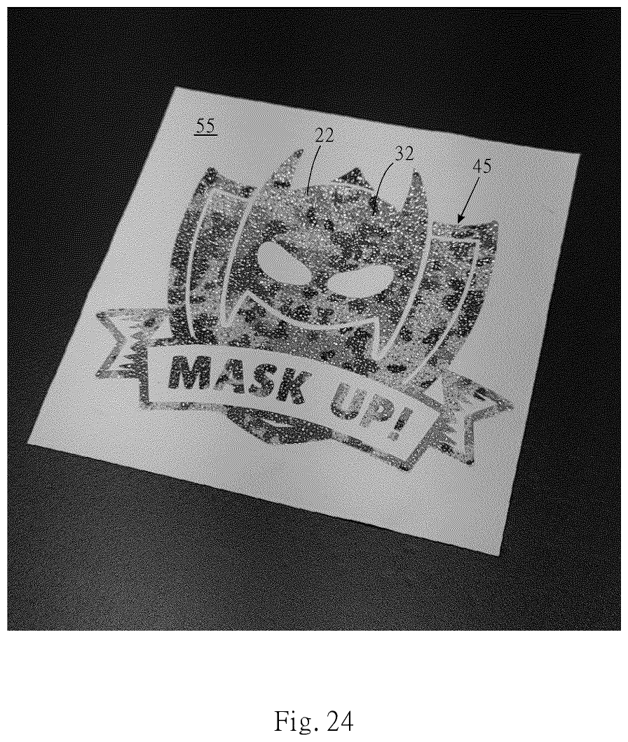

Another method of making the graphic 45 is as shown in FIGS. 23 to 35 of the U.S. patent application Ser. No. 18/883,359 and Ser. No. 18/931,621. Users can cut out graphics on the film material 20 and the printing material 10 respectively, and then attach the graphics cut out from the film material 20 and the printing material 10 to form the complete graphic 45. Some users may use this manufacturing method to directly cut out graphics on the film material 20. In order to enable users to easily remove unnecessary parts (waste material) and leave the cut graphic, the invention provides an embodiment of the film material 20 (20J) shown in FIG. 11, the film material 20J can be the film material described in any of the above embodiments, and further comprises: a positioning film 60, one surface of the positioning film 60 is a positioning surface and has a glue layer 62. The glue layer 62 is a non-sticky adhesive with release properties and adhering properties, such as pressure-sensitive adhesive (PSA). Through the glue layer 62, the film layer 22 and the adhering layer 24 can be easily separated from the positioning film 60, and after separation, the film layer 22 and the adhering layer 24 can still be adhered back and positioned on the positioning film 60.

When users want to cut out graphics on the film layer 22, the release layer 26 of the film material 20 can be torn off, and the positioning film 60 can be attached to the film layer 22 and the adhering layer 24, as shown in FIG. 12, and then cut out graphics from the film layer 22 and the adhering layer 24 in FIG. 12. When the film layer 22 or a graphic cut out from the film layer 22 is accidentally separated from the positioning film 60, the film layer 22 or the cut graphic can still be adhered back and positioned on the positioning film 60. For example, when peeling off the waste material other than the cut graphic from the film layer 22 and the graphic is accidentally separated from the positioning film 60, the user can adhere the graphic back and position it on the positioning film. Glue of the glue layer 62 only remains on the positioning film 60 and will not transfer/stick to the film layer 22 or the cut graphic.

FIGS. 22 to 33 show different application examples of the graphic 45 being heat printed on a fabric 55. Please refer to FIG. 22. When the film layer 22 of the graphic 45 is the film layer (22E, 22F) of FIG. 6 or FIG. 7, at night, the micro glass bead layer 25 of the film layer 22 produces reflection, causing the graphic 45 to produce a light-reflective effect.

FIG. 23 shows that exteriors of the graphic 45 and the pattern 32 have a texture effect formed by the textures 222 of the film layer 22.

FIG. 24 shows that the pattern 32 of the graphic 45 is covered by the film layer 22, and the film layer 22 has glitter powder. Therefore, a surface of the graphic 45 produces a metallic luster effect.

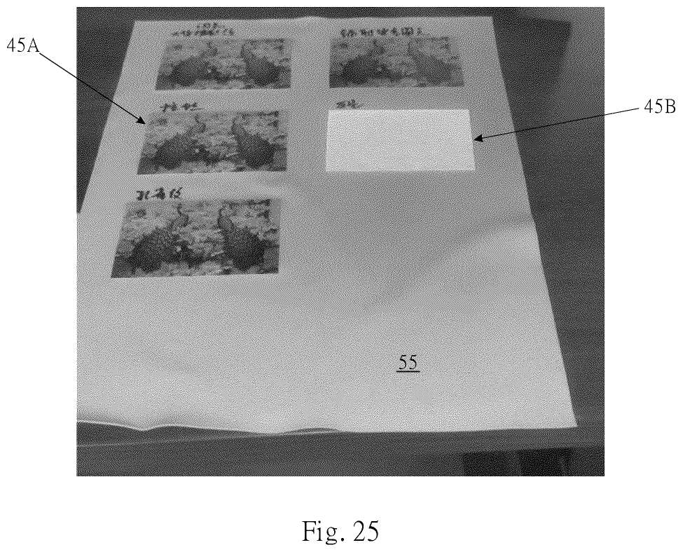

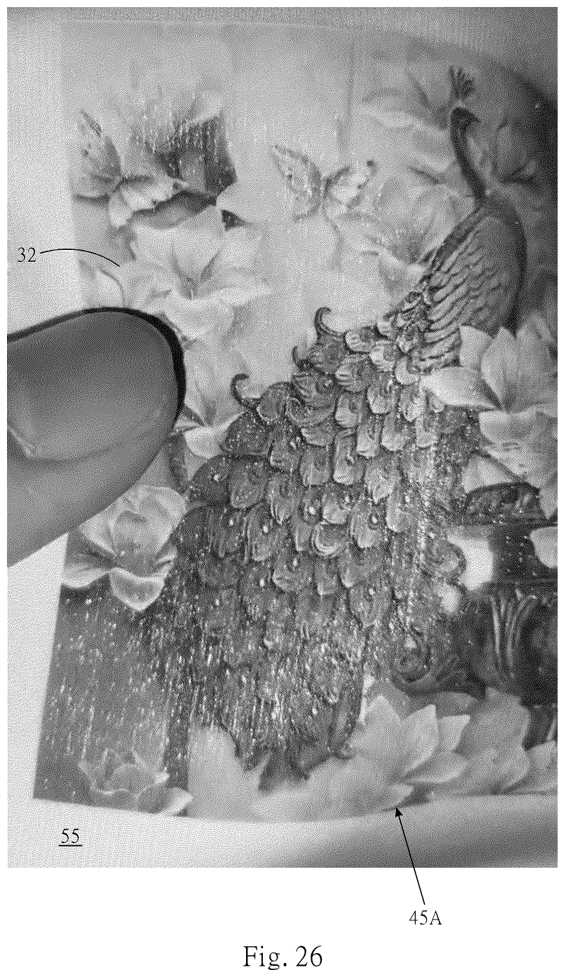

The film layer 22 of a graphic 45B in FIG. 25 is a light-reflective film layer with the micro glass bead layer 25 of FIG. 6 or 7. FIG. 25 shows that the graphic 45B reflects light and provides safety effect. FIG. 26 shows that the film layer 22 of a graphic 45A has stripe textures, so that the graphic 45A has a stripe texture surface effect.

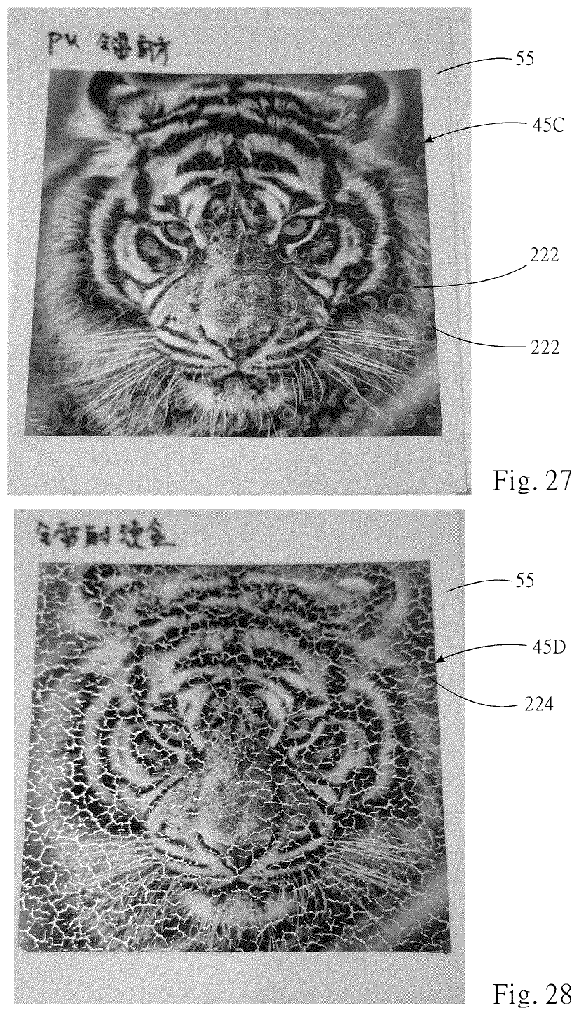

The textures 222 of the textured surface 221 of the film layer 22 of a graphic 45C in FIG. 27 are made into textures with a laser effect, so that the film layer 22 forms a transparent film processed by laser, and the graphic 45C produces laser textures.

The film material in FIG. 28 is the film material 20B in FIG. 3B, and the film layer 22 thereof is a bronzing film with the metal layer 28, so that a graphic 45D forms bronzing textures 224 and a bronzing effect.

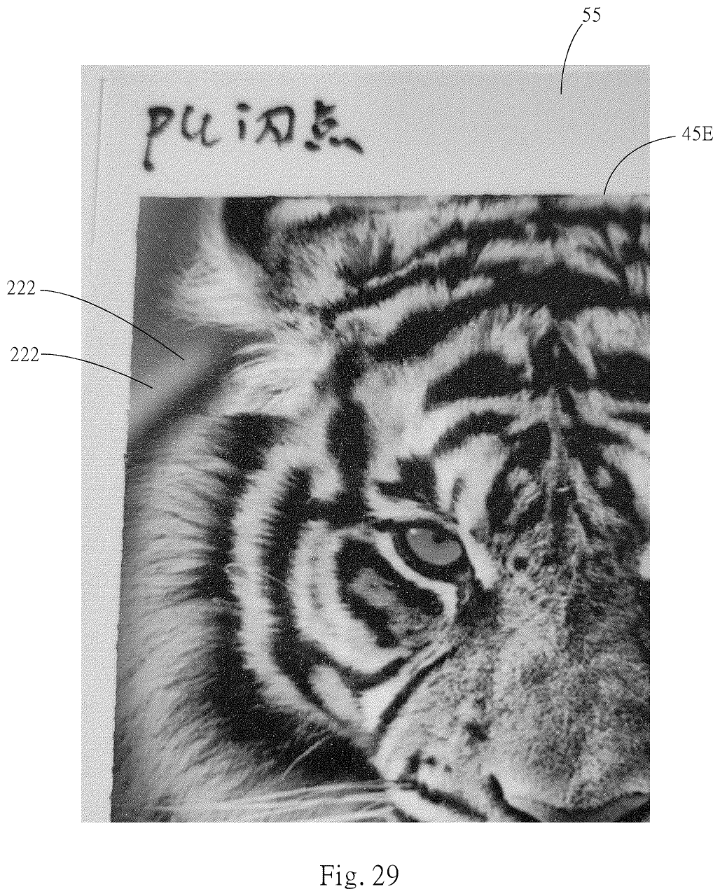

The film layer in FIG. 29 has fine dotted textures, so that a graphic 45E has the fine dotted textures 222.

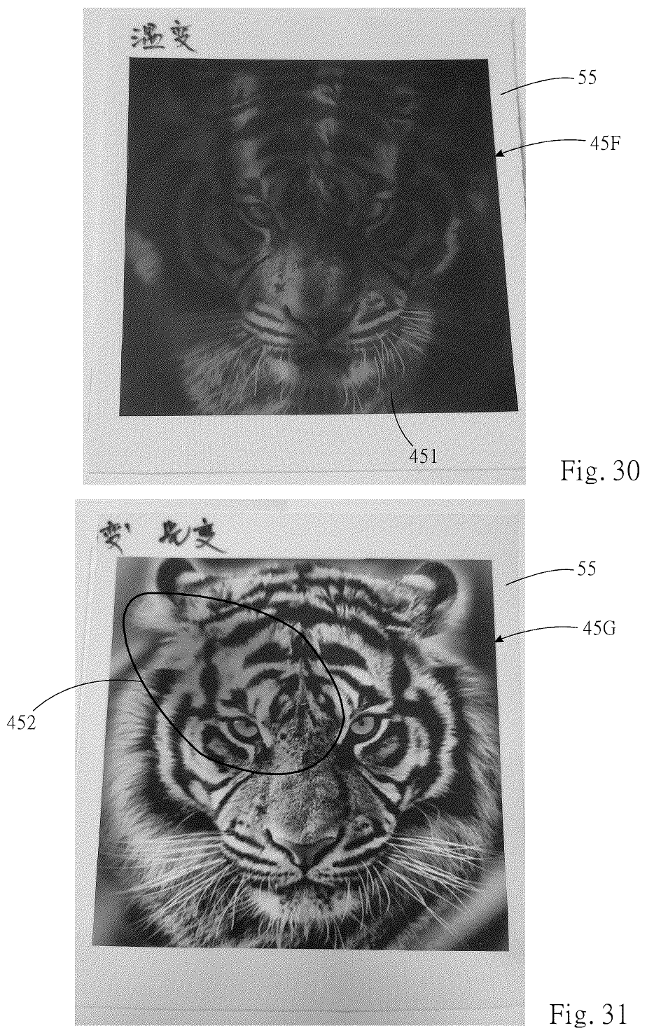

In the film material in FIG. 30, the film layer or the adhering layer is added with temperature-variable powder. The film material forms a transparent or translucent temperature-variable film material that changes color due to changes in temperature. A temperature of a palm produces a discolored palm print 451 on a graphic 45F.

In the film material of FIG. 31, optical-variable powder is added to the film layer or the adhering layer, and the film material forms a transparent or translucent optical-variable film material. When light of a specific frequency is irradiated on a graphic 45G, a portion 452 of the film material irradiated by the light will change color.

If an additive uses optical-variable powder, temperature-variable powder or UV absorber, preferably, UV absorber is added to the film layer, and temperature-variable powder and optical-variable powder are added to the adhering layer (hot melt glue layer).

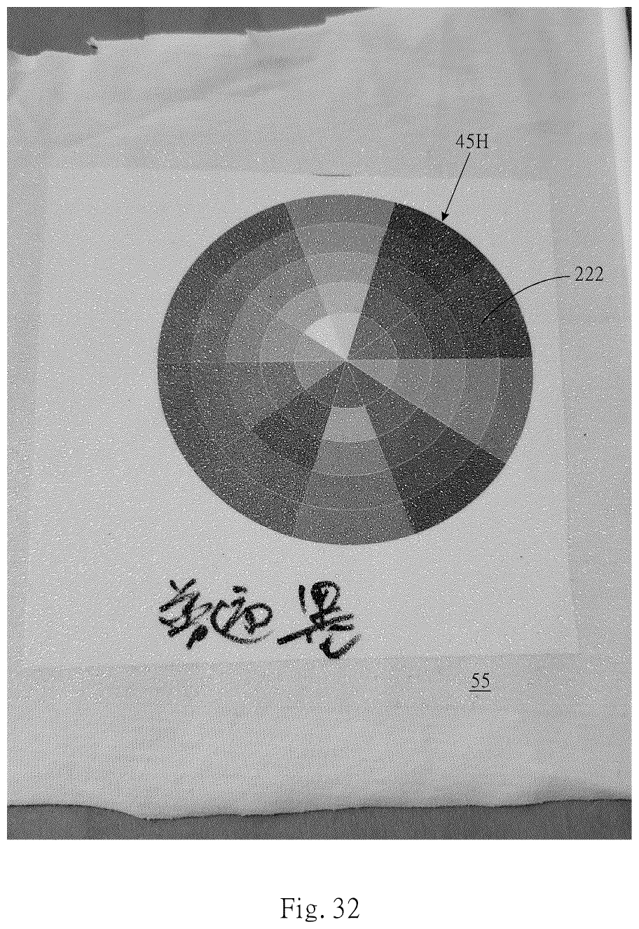

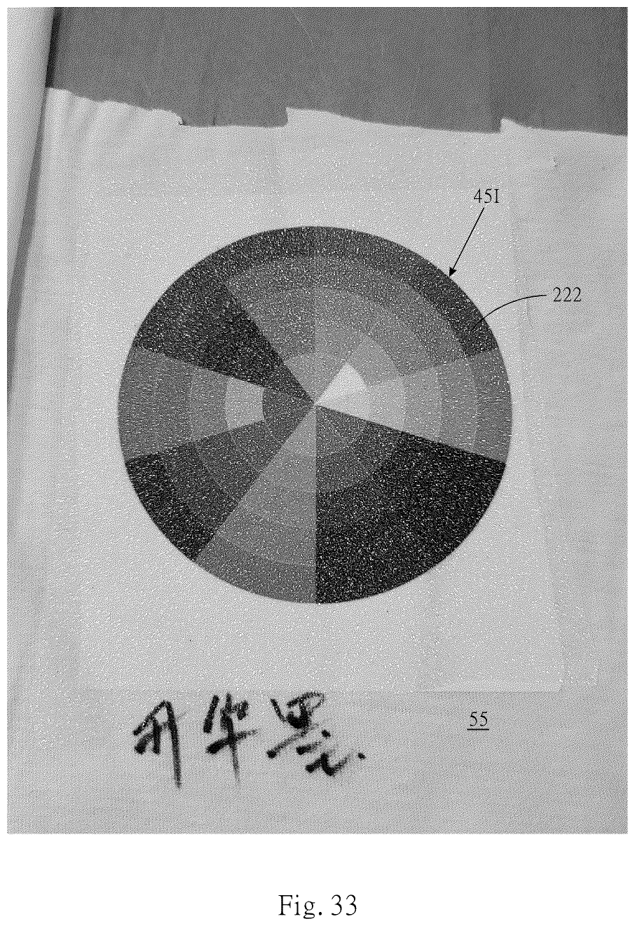

FIGS. 32 and 33 show color graphics 45H, 45I printed with sublimation ink, the graphics 45H, 45I are heat printed on the fabric 55, and the film layers of the two graphics 45H, 45I are provided with the fine dotted textures 222. Wherein the adhering layer 24 of the film material 20 in FIG. 32 is not TPEE hot melt glue, when the sublimation ink of the graphic 45H is sublimated to polyester fibers of the fabric 55, color and luster of the sublimation ink will be affected by the fibers, causing an ink color of the graphic 45H poorly developed, losing its vividness, and appearing to fade, and patterns of the graphic 45H are unsharp.

The adhering layer 24 of the film material in FIG. 33 is TPEE hot melt glue. When the sublimation ink of the graphic 45I is sublimated to polyester fibers of the fabric 55, the TPEE hot melt glue can cause the sublimation ink to develop color, making a color of the graphic 45I to maintain vividness and its patterns are clear.

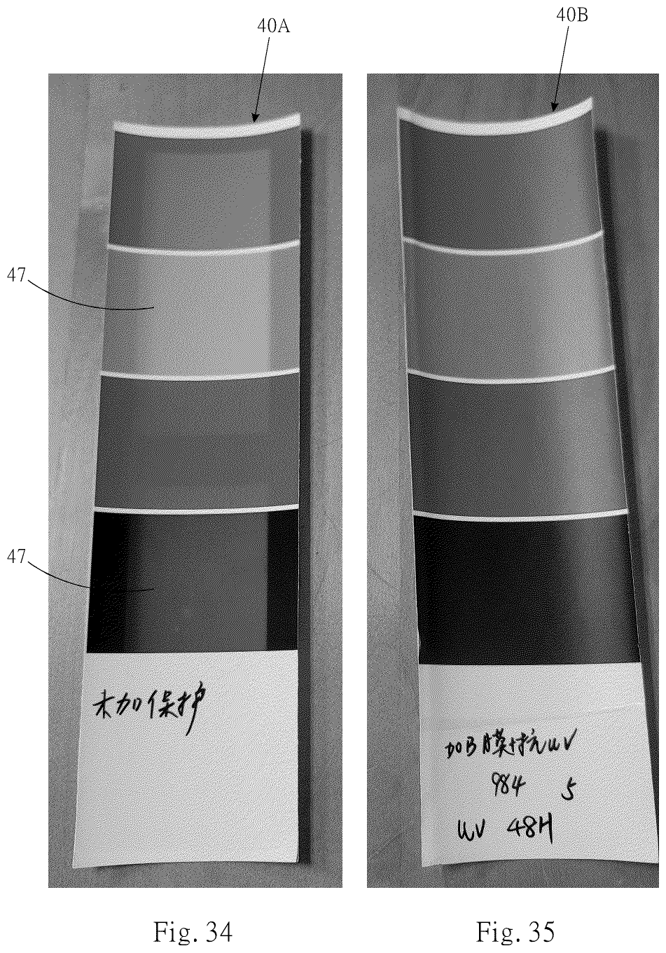

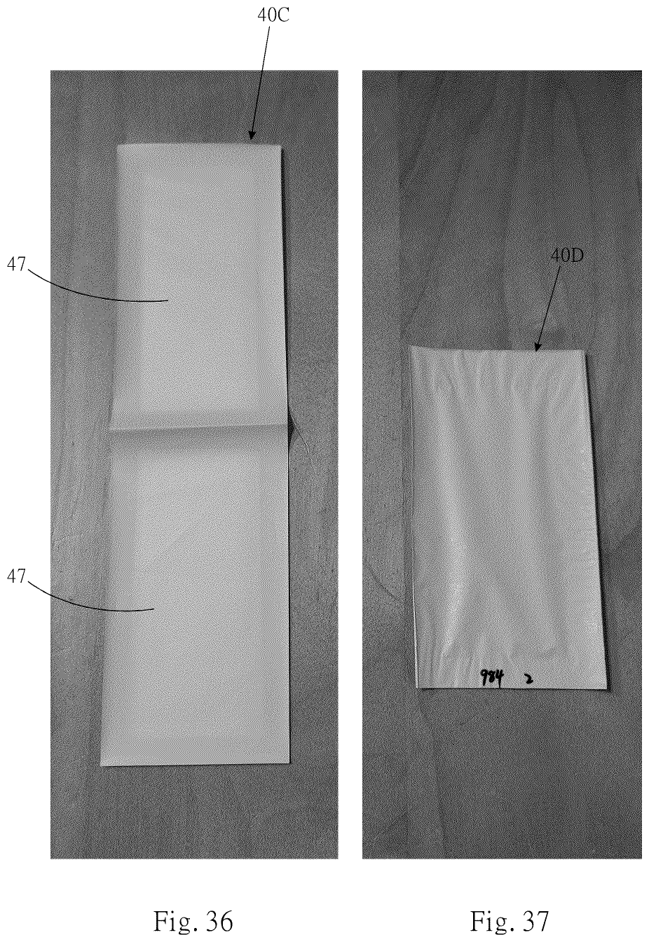

FIGS. 34 to 37 show four composite film materials 40A to 40D, which are formed by attaching the film material 20 with the printing material 10, and each of the printing materials 10 is printed with color ink. Wherein the film layers 22 of the composite film materials 40A, 40C in FIGS. 34, 36 do not have UV absorber added, while the film layers 22 of the composite film materials 40B, 40D in FIGS. 35, 37 have UV absorber added. The four composite film materials 40 have been tested in sunlight for 48 hours. The composite film materials 40A, 40C in FIGS. 34 and 36 both have fading conditions, and fading positions are as indicated by marks 47; while the composite film materials 40B, 40D added with UV absorber have no fading and the ink maintains vivid color.

Luminous powder can be added to the film layer of the invention, and the graphic becomes a luminous graphic through a luminous material in the film layer.

The graphic 45 of the invention can be heat printed on various items, such as cloth, leather, plastic film, paper, wood flake or foil, etc., so that the graphic 45 with the pattern 32 can be formed on clothes, pants and other cloths or other types of items. As shown in FIGS. 20 and 22, being protected and isolated by the film layer 22, the graphic 45 will not be damaged, ink or toner of the pattern 32 of the graphic 45 will not smudge, scatter, spread or fall off, an integrity of the graphic 45 and the pattern 32 can be kept on cloths, and vividness of colors of the pattern 32 can be maintained. Tested by the inventor, a cloth was washed with water twenty times at a water temperature of 60° C. and dried after each washing, the graphic 45 and the pattern 32 remained intact, the colors remained bright and vivid, and there was no damage or color fading. The graphic 45 shown in each of the figures and the composite film materials in FIGS. 32 to 37 of this specification are resistant to water washing and an integrity of the graphic 45 can be maintained. The film layer 22 and the adhering layer 24 are transparent or translucent, and can display the pattern 32 of the graphic 45.

When anti-UV additive or antioxidant are added to the film layer 22 of the film material 20, the graphic 45 can resist sunlight and UV rays, preventing the pattern 32 of the graphic 45 from fading and maintaining vivid colors of the graphic 45.

The film layer 22 of the graphic 45 becomes a functional layer, so that the pattern 32 has various texture effects as shown in the figures, or 2D/3D visual effects or light-reflective functions. The film layer 22 can also be plated with a layer of zinc sulfide or a metal layer, so that the graphic 45 has an iridescent effect or a bronzing effect. The metal layer does not cover the entire film layer 22, and the pattern 32 can still be displayed. Pearlescent powder, glitter powder, luminous powder, optical-variable powder, and temperature-variable powder can also be added to the film layer 22, so that the graphic 45 has an iridescent effect, a metallic effect, or a luminous effect, or can change color due to changes in light or temperature. Or spice/perfume can be added to the film layer 22. Each of the above-mentioned effects enhances aesthetics of the pattern and the graphic and provides visual and olfactory sensations.

Oxygen causes ink dyes and sublimation ink to fade faster. The film material 20 of the invention uses the adhering layer 24 to adhere with the printing material 10. The adhering layer 24 can isolate most of the oxygen, reduce a chance of the pattern 32 of the graphic 45 coming into contact with oxygen, and avoid or slow down fading of the graphic 45.

When TPEE hot melt glue or polyester adhesive is used as the adhering layer 24, a problem of poor color development of sublimation ink can be solved, so that the graphic 45 of sublimation ink has bright colors and the clear pattern 32.

The film material 20 of the invention is designed for printing materials, making it convenient for users or businesses to customize the graphic 45. The invention can reduce materials required for customized heat printing graphics, reduce a number of customized material styles sold in stores, and can be more environmentally friendly.

If industrial equipment is used to make materials capable of withstanding water washing in businesses or homes, industrial equipment is expensive, has problems with volatile organic compound emissions, which pollute the environment, and are harmful to the human body, so it is not ideal and feasible to use industrial equipment in stores or at home. On the other hand, by using the techniques of the invention to customize the graphic 45, home printers and sublimation ink are equipment and materials that are harmless to the human body and do not pollute the environment.

Although the invention has been disclosed as above with the embodiments, it is not intended to limit the invention. A person having ordinary skill in the art to which the invention pertains can make various changes and modifications without departing from the spirit and scope of the invention. Therefore, scope of protection of the invention shall be subject to what is defined in the pending claims.

What is claimed is

1. A film material capable of solving printing materials incapable of washing with water, comprising:
a release layer;
a film layer being a polymer film, provided on a surface of the release layer; and
an adhering layer provided on a surface of the film layer; the film layer and the adhering layer being capable of separating from the release layer.

2. The film material as claimed in claim 1, wherein the film layer is transparent or translucent.

3. The film material as claimed in claim 1, wherein the adhering layer is transparent or translucent.

4. The film material as claimed in claim 1, wherein the release layer has a first surface, the first surface has textures; a surface of the film layer in contact with the first surface is a textured surface with textures.

5. The film material as claimed in claim 1, wherein a surface of the film layer combined with the release layer is a textured surface with textures.

6. The film material as claimed in claim 1, comprising a positioning film with a surface having a glue layer; the film layer and the adhering layer being capable of separating from the release layer, and adhering to the surface of the positioning film with the glue layer, the film layer and the adhering layer being capable of separating from the positioning film and adhering back and positioning on the glue layer of the positioning film after separation.

7. The film material as claimed in claim 1, wherein the film layer is a light-reflective film layer with a layer of transparent or translucent micro glass beads.

8. The film material as claimed in claim 7, further comprising a layer of zinc sulfide disposed on the micro glass bead layer.

9. The film material as claimed in claim 1, wherein the film layer or the adhering layer is added with at least one of the following additives: ultraviolet absorber, antioxidant, luminous material, fluorescent material, pearlescent material, optical-variation material, temperature-variable material or glitter powder.

10. The film material as claimed in claim 9, wherein both the film layer and the adhering layer of the film material have at least one of the additives, or only the film layer of the film material has at least one of the additives, or only the adhering layer of the film material has at least one of the additives.

11. The film material as claimed in claim 1, wherein a surface of the film layer is provided with a metal layer, the metal layer does not cover the film layer completely.

12. The film material as claimed in claim 4, wherein the textures of the film layer are concave-convex textures or textures forming a laser effect.

13. The film material as claimed in claim 1, wherein a surface of the film layer has micro optical components, including: micro convex lenses, micro concave lenses, and micro convex or concave water droplet-shaped components.

14. The film material as claimed in claim 1, wherein the film layer has at least two stacked layer portions, at least comprising a first layer portion and a second layer portion, each of the layer portions is a polymer film, and the second layer portion is combined with the adhering layer.

15. The film material as claimed in claim 14, wherein a surface of the first layer portion of the film layer is a textured surface with textures.

16. The film material as claimed in claim 14, wherein at least one of the layer portions is added with at least one of the following additives: ultraviolet absorber, antioxidant, luminous material, pearlescent material, fluorescent material, optical-variation material, temperature-variable material or glitter powder.

17. The film material as claimed in claim 14, wherein the first layer portion is added with ultraviolet absorber or antioxidant; the second layer portion is added with luminous material, fluorescent material, pearlescent material, optical-variation material, temperature-variable material or glitter powder.

18. The film material as claimed in claim 14, wherein the first layer portion is a light-reflective film with a layer of micro glass beads; the second layer portion has no additives or is added with at least one of the following additives: ultraviolet absorber, antioxidant, luminous material, pearlescent material, fluorescent material, optical-variation material, temperature-variable material or glitter powder.

19. The film material as claimed in claim 1, wherein the adhering layer is an adhesive made of polypropylene (PP), thermoplastic elastomer (TPE), thermoplastic polyurethane (TPU), polyethersulfone (PES), ethylene vinyl acetate (EVA) or polyurethane reactive (PUR), capable of generating viscosity when being heated.

20. The film material as claimed in claim 1, wherein the adhering layer is a thermoplastic elastomer (TPEE) adhesive or a polyester adhesive, capable of generating viscosity when being heated.

21. The film material as claimed in claim 1, wherein the film layer is polyurethane resin, comprising polycarbon polyurethane, polyether polyurethane or polyester polyurethane.
